(19) United States
(12) Patent Application Publication
(10) Pub. No.: US 2005/0203668 A1
(43) Pub. Date: Sep. 15, 2005

(54) PDA control of a dispensing device

(76) Inventors: Robert Ciardella, Rancho Santa Fe, CA (US); Alec Babiarz, Encinitas, CA (US); Chris Giusti, San Marcos, CA (US); Thomas Laferl Ratledge, San Marcos, CA (US)

Correspondence Address: CALFEE, HALTER & GRISWOLD, LLP, 800 SUPERIOR AVENUE, SUITE 1400, CLEVELAND, OH, 44114, US

(21) Appl. No.: 10/797,768

(22) Filed: Mar. 10, 2004

(51) Int. Cl. G05B 15/00

(52) U.S. Cl. 700/283; 700/83

(57) ABSTRACT

A fluid dispensing system and method therefore having a PDA controller is provided. The system includes a dispensing apparatus, a positioning system and a general purpose PDA for controlling the system. The PDA optionally includes dispensing system logic for communicating with the dispensing apparatus. The dispensing system logic optionally includes one or more of positioner control logic, create program logic, store program logic, teach logic and recall program logic. The PDA communicates with the positioning system and/or the dispensing apparatus by a wired and/or wireless connection. Optionally a plurality of dispensing systems are networked together and the PDA communicates with one or more dispensing systems via a connection to the network. The network may be wired or wireless, and the PDA may have a wired or a wireless connection to the network.

### FIELD OF THE INVENTION

This invention relates generally to material dispensing systems. More particularly, the invention relates to monitoring and/or controlling such systems with a personal data assistant (“PDA”).

### BACKGROUND OF THE INVENTION

Material application systems may be broadly categorized as liquid or powder dispensing systems. Liquid dispensing systems may include, but are not limited to, adhesives, sealants, caulks, paint and so forth. Such systems may be manual or robotic.

Robotically dispensing systems generally include a dispensing apparatus coupled to a positioning system. An example of such a dispensing robot is the Ultra™ TT Automation Series line of dispensing systems available from EFD Inc. of East Providence, R.I., including the Tabletop XYZ dispensing systems of that line. In these systems, the dispensing apparatus is typically an air-powered, syringe- or valve-based device and the positioning system is typically an electronically controlled positioning platform. Many parameters of the operation of the dispensing apparatus and the positioning system, including but not limited to the type of fluid deposit (e.g., dot, line, circle, arc or fill), the size of the fluid deposit and the placement of the deposit, are monitored and controlled.

The monitoring and/or control of such systems has typically been accomplished by a teach pendant or a personal computer coupled to the positioning system. A teach pendant, also known as a teach box, is a hand-held device used to instruct a robot. Teach pendants typically comprise a physical control device, such as a joystick, and often include logical control elements.

Known teach pendants are devices which are specifically adapted to control a specific robot or series of robots, and are thus expensive to make and relatively difficult to learn to use. For example, U.S. Pat. No. 5,790,401, issued to Shields, describes a teach pendant comprising a computing device housing a display screen, a joystick ball and a removably mounted joystick device. Such a housing, including such peripherals, is not generally available, and thus must be specifically designed and produced, usually for a particular robot, thus increasing its cost. In an additional example, PCT publication WO 01/71878 from Kuka Development Laboratories, Inc., describes a computerized pendant which is customized for multiple input devices and includes a docking port for connection to a controller and/or a control handle. As with U.S. Pat. No. 5,790,401, such a device is not generally available, and thus must also be specifically designed and produced (also increasing cost).

It is also known to use a personal computer to monitor and control a robotic dispensing system. Such computers are generally not portable, however, which hinders control and monitoring of the robotic system (e.g., as the controller/operator is preferably proximate to the system for ease of use and safety purposes). Use of a laptop personal computer does not solve this problem, however, as even the smallest laptops are still too unwieldy to be both held (i.e., supported) and used (i.e., have information relating to control of the system inputted by the user while watching and being proximate to the system) conveniently.

It is an object of the present invention to provide apparatus and methods for facilitating monitoring and control of a robotic dispensing system by use of a portable, convenient and relatively inexpensive, general purpose computing device.

### SUMMARY OF THE PRESENT INVENTION

In accordance with one embodiment of the present invention, a fluid dispensing system having a PDA controller is provided. The system includes a dispensing apparatus, a positioning system and a general purpose PDA for controlling the system. The PDA optionally includes dispensing system logic for communicating with at least the positioning system. The dispensing system logic optionally includes positioner control logic, create program logic, store program logic and recall program logic. The PDA communicates with the positioning system and/or the dispensing apparatus by a wired and/or wireless connection. In an embodiment, a plurality of dispensing systems are networked together and the PDA communicates with one or more dispensing systems via a connection to the network. The network may be wired or wireless, and the PDA may have a wired or a wireless connection to the network.

In accordance with another embodiment of the present invention, a method for controlling a fluid dispensing system with a PDA is provided. The method includes the steps of connecting a general purpose PDA to the fluid dispensing system and facilitating the exchange of information (optionally including control commands) between the PDA and the fluid dispensing system.

An advantage of the present invention is that a fluid dispensing system may be controlled by a device which is small, portable, and relatively inexpensive and easy to acquire. A further advantage is that such a dispensing system may be controlled by an inexpensive, general purpose computing device. A still further advantage is that communication between such a device and such a dispensing system may be wireless, allowing freer range of movement by the user. Yet still another advantage is that multiple dispensing systems may be controlled by one relatively inexpensive, general purpose device by either wired and/or wireless communication.

These and other aspects and advantages of the invention will be readily understood and appreciated from the following detailed description of one or more embodiments of the invention with reference to the accompanying Figures.

### DESCRIPTION OF THE FIGURES

The invention may take physical form in certain parts and arrangement of parts, embodiments of which will be described in detail in this specification and illustrated in the accompanying drawings which form a part hereof, and wherein:

FIG. 1 is a functional block diagram of a PDA controlled dispensing system in accordance with an embodiment of the present invention;

FIG. 2 is a functional block diagram of a PDA controlled dispensing system including wireless communication in accordance with an embodiment of the present invention;

FIG. 3 is a functional block diagram of a PDA controlled dispensing system including a network in accordance with an embodiment of the present invention;

FIG. 4 is a functional block diagram of a PDA controlled dispensing system including a wireless network in accordance with an embodiment of the present invention; and

FIG. 5 is an diagram of logical components of a PDA of a PDA controlled dispensing system in accordance with an embodiment of the present invention.

### DETAILED DESCRIPTION OF PREFERRED AND ALTERNATE EMBODIMENTS

The following includes definitions of exemplary terms used throughout the disclosure. Both singular and plural forms of all terms fall within each meaning. Except where noted otherwise, capitalized and non-capitalized forms of all terms fall within each meaning:

As used herein, “PDA” or “Personal Data Assistant” is used generically and is used interchangeably with “general purpose PDA.” A PDA of the present invention is a general purpose computing machine sized and shaped to generally fit into a hand of a user. A “general purpose computing machine” as used herein is a computer which is designed to perform different, multiple and varying software applications as are generally available, such as, for example, e-mail, image viewing, calendar, address book, spreadsheet and word processing, and which is not specifically designed or adapted for a single purpose, use and/or implementation. A PDA of the present invention runs any suitable operating system, including but not limited to any version of the Palm OS™ and Windows CE™. Exemplary PDA's of the present invention include but are not limited to the Palm Tungsten™ and Zire™ lines, the Toshiba Pocket PC line and the Hewlett Packard iPAQ™ line, and further include PDA and phone combination devices, such as, e.g., the Handspring Treo™ line. Generally speaking, a PDA of the present invention is generally commercially available in that it is not the product of a special order or design customization. A PDA generally has a display screen and at least one user input mechanism, including but not limited to a touch screen functional with an electronic stylus.

As used herein, “logic” is used generically and includes but is not limited to hardware, software and/or combinations of both to perform a function.

As used herein, “software” is used generically and includes but is not limited to one or more computer executable instructions, routines, algorithms, modules or programs including separate applications or from dynamically linked libraries for performing functions as described herein. Software may also be implemented in various forms such as a servlet, applet, stand-alone, plug-in or other type of application. Software can be maintained on various computer readable mediums as known in the art.

As used herein, “network” is used generically and includes but is not limited to the Internet, intranets, Virtual Private Networks, Wide Area Networks and Local Area Networks.

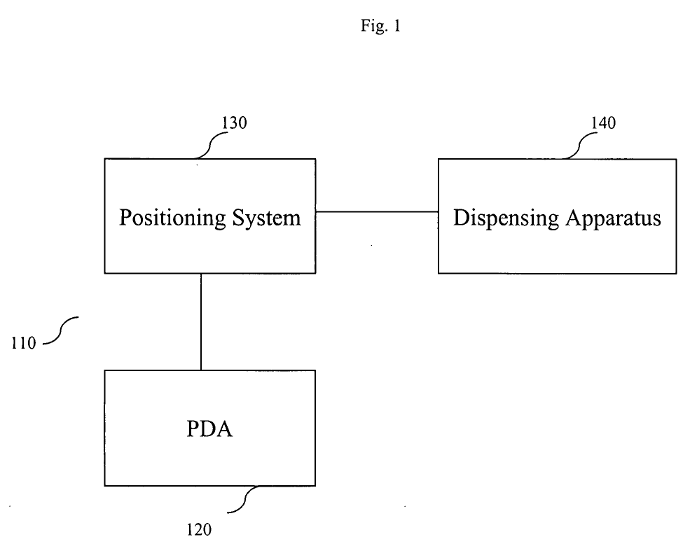

With reference to FIG. 1, the invention contemplates a dispensing system 110 including a dispensing apparatus 140 and positioning system 130 controlled and/or monitored by a PDA 120. Dispensing system 110 dispenses any suitable material, including powder and/or liquid (fluid). In the embodiments described herein, dispensing system 110 is a fluid dispensing system. While the described embodiments herein are in the context of an exemplary fluid dispensing material application system, such description is intended to be illustrative in nature and should not be construed in a limiting sense. The present invention may be used in a wide variety of material application systems, including but not limited to adhesives, sealants, coatings, powder spraying systems and liquid spraying systems, and further may be used in connection with the application of material to a wide variety of articles such as but not limited to boxes, cartons, packages, car parts, electronic components, metal parts, non-metal parts, cans and other containers including biodegradable containers, and so forth. The foregoing is not intended to be an exhaustive list by any means and should not be construed in a limiting sense. Still further, although the described embodiments incorporate various aspects of the invention into a single system, such description is for convenience and ease of understanding and not intended to be limiting. The various aspects of the invention may be used individually or in any number of various combinations in a particular system based on the particular needs of the customer.

Dispensing apparatus 140 is any suitable mechanism for dispensing material, such as, e.g., a fluid. An exemplary dispensing apparatus is the dispensing mechanism of the Ultra™ TT Automation Series line of dispensing systems available from EFD Inc. of East Providence, R.I., including the Tabletop XYZ dispensing systems of that line. In these systems, the dispensing apparatus is typically an air-powered, syringe- or valve-based device for dispensing fluid.

The dispensing apparatus 140 is coupled to positioning system 130. Positioning system 130 is any suitable mechanism for positioning one or more receptacles and/or other receiving medium for receiving fluid dispensed by dispensing apparatus 140. An exemplary positioning system is the positioning system of the Ultra™ TT Automation Series line of dispensing systems available from EFD Inc. of East Providence, R.I., including the Tabletop XYZ dispensing systems of that line. In these systems, the positioning system is typically an electronically controlled platform capable of vertical and/or horizontal movement.

While dispensing apparatus 140 and positioning system 130 have been described herein as separate components, it will be understood that dispensing apparatus 140 and positioning system 130 may be integral, and often are integral. Typically dispensing apparatus 140 and positioning system 130 are adapted to function together as a dispensing robot. For example, in the Tabletop XYZ dispensing systems referenced above, the dispensing apparatus 140 and the positioning system 130 are sized and adapted to fit on top of a bench top, mobile cart or similar structure. Liquid receptacles are placed on a tray which is placed upon the positioning system 130. Dispensing apparatus 140 is positioned above the tray to facilitate dispensing liquid into the receptacles. The positioning system 130 and/or the dispensing apparatus 140 are programmed to move to facilitate liquid dispensing into a plurality of receptacles on the tray.

PDA 120 electronically communicates with positioning system 130 and/or dispensing apparatus 140 to facilitate control and/or monitoring thereof. This electronic communication is facilitated by any suitable means. For example, the PDA 120 has one or more input/output ports, including but not limited to one or more serial port (e.g., RS-232), one or more USB port and/or one or more IEEE 1394 port. A wire, cord or other suitable cable is connected to the PDA 120 via any suitable input/output port. The wire is connected at the other end to at least the positioning system 130 and also optionally the dispensing apparatus 140. The positioning system 130 and/or the dispensing apparatus 140 have one or more suitable input/output ports for receiving the wire. For example, the positioning system 130 may include a serial, USB and/or IEEE 1394 interface card which includes a socket for the wire and is adapted to be in electronic communication with the circuitry of the positioning system 130. In other embodiments of the present invention, described below, electronic communication is facilitated by wireless communication, including by a wireless network.

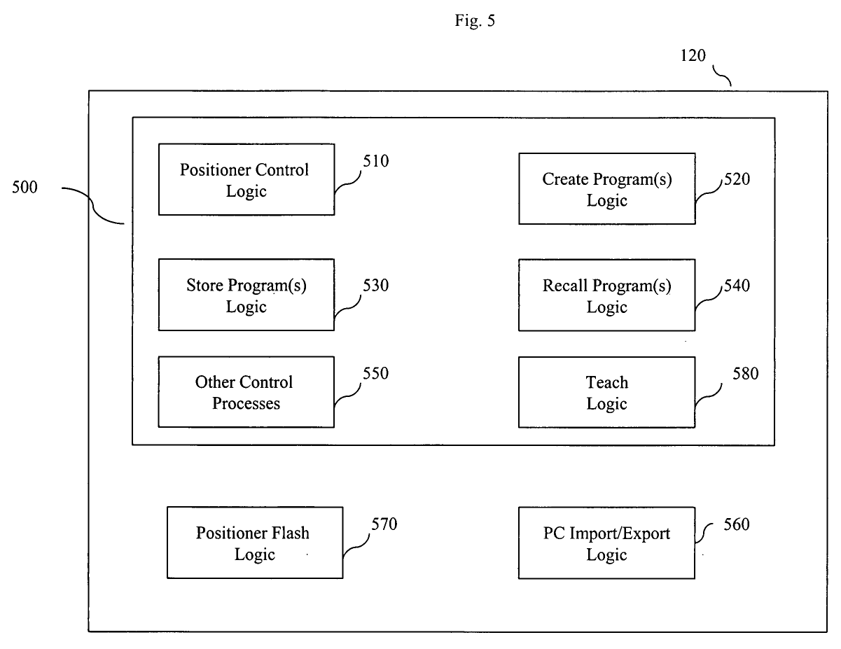

With reference to FIG. 5, PDA 120 includes dispensing system logic 500. Dispensing system logic 500 includes any suitable step(s), process(es), forumla(e), instruction(s) and/or procedures for controlling and/or monitoring the dispensing apparatus 140 and/or the positioning system 130. For example, dispensing system logic 500 may include one or more of positioner control logic 510, create program(s) logic 520, store program(s) logic 530, recall program(s) logic 540, teach logic 580 and any other control processes logic 550.

Positioner control logic 510 includes any suitable step(s), process(es), forumla(e), instruction(s) and/or procedures for controlling the position of the dispensing apparatus, the positioning system, any component thereof, any fluid therein and any receptacle and/or tray thereon. For example, positioner control logic 510 displays on the display screen an option or a list of user options regarding actions which are capable of being performed by the dispensing apparatus 140 and/or the positioning system 130. A user selects one or more of these actions by any suitable means (e.g., by touching the displayed option with the electronic stylus) and the selection is electronically communicated to the dispensing apparatus and/or the positioning system, which performs the selected action. It will be understood that any number of input parameters regarding such actions may be inputted by the user via the PDA, and furthermore that any combination of actions may be so inputted. Exemplary actions of positioner control logic include, but are not limited to, (for, e.g., a dispensing system having a needle dispenser and a tray on the positioning system), rotating the needle, aligning the needle to a mark, jogging the needle to a mark and adjusting the needle alignment with the mark.

Create program logic 520 includes any suitable step(s), process(es), forumla(e), instruction(s) and/or procedures for creating a programmed series of actions for the positioning system and/or the dispensing system. For example, create program logic 520 facilitates teaching of the dispensing robot (i.e., the positioning system and/or the dispensing system). Create program logic 520 may work with positioner control logic 510, recording the actions initiated by the user and performed by the dispensing robot, to create a programmed series of actions. Create program logic 520 may also facilitate modification or editing of the program.

Upon creating such a program, the program may be stored for later use by store program logic 530. Store program logic 530 includes any suitable step(s), process(es), forumla(e), instruction(s) and/or procedures for storing such a program and/or one or more components (or functions or routines) of such a program. Such a program may be used later by the same dispensing system or other, similar dispensing systems. Such a program is recalled from memory by recall program logic 540. Recall program logic 540 includes any suitable step(s), process(es), forumla(e), instruction(s) and/or procedures for recalling a stored program or component thereof. Such a recalled program or component can be run on any suitable dispensing system, including upon the dispensing system upon which the program was created.

Teach logic 580 includes any suitable step(s), process(es), forumla(e), instruction(s) and/or procedures for teaching the dispensing apparatus to perform a function, a process, a series of either or a combination of both. For example, teach logic 580 facilitates teaching of the dispensing apparatus by a user to perform a certain task, such as dispensing a certain amount of liquid into each of a plurality of vials contained on a tray on the positioning system. Teach logic 580 optionally includes the logic contained in one or more of positioner control logic 510, create program logic 520, store program logic 530, recall program logic 540 and other control processes logic 550.

While several logical functions included in dispensing system logic 500 have been described herein, it will be understood that any suitable other control processes 550 may be included in dispensing system logic 500. Exemplary other control processes 550 include, but are not limited to, monitoring process(es) for monitoring the over-all performance of the dispensing robot or any component thereof.

With further reference to FIG. 5, PDA 500 further optionally includes PC import/export logic 560. PC import/export logic 560 includes any suitable step(s), process(es), forumla(e), instruction(s) and/or procedures for facilitating import to and/or export from a personal computer of a program or other data. Software, including but not limited to programs for controlling a dispensing robot, and/or data (e.g., embedded) is optionally created on a personal computer (not shown) and uploaded to PDA 500 via PC import/export logic 560. Additionally, software and/or data optionally created and/or stored on PDA 500 is optionally downloaded to a personal computer via PC import/export logic 560. In this regard materials (software and/or data) can be created for a dispensing robot on a personal computer (which may not be proximate to the dispensing robot) and imported to the dispensing robot via the PDA. Similarly, information contained on a PDA (e.g., runtime data) can be ported to a personal computer for further analysis. In embodiments of the present invention including a plurality of dispensing robots (as described further herein), data from the plurality of robots may be collected on such a personal computer (as transferred by PDA 500) for analysis across multiple dispensing robots.

With still further reference to FIG. 5, PDA 500 further optionally includes positioner flash logic 570. Positioner flash logic 570 includes any suitable step(s), process(es), forumla(e), instruction(s) and/or procedures for facilitating import (flash) of embedded software to the positioning system and/or the dispensing apparatus. The embedded software of, e.g., the positioning system, controls the inner functions of the positioning system. It may be advantageous to update and/or upgrade such embedded software. Typically, the process of uploading such a change is called “flashing” the internal memory (e.g., flash ROM). Such an update is optionally uploaded to PDA 500. Via positioner flash logic 570, the PDA flashes the memory of the positioning system to facilitate revision and/or update of the embedded software of the positioning system 130.

With reference again to FIG. 1, a user controls the positioning system 130 and/or the dispensing apparatus 140 via PDA 120. Upon connecting the PDA 120 to the positioning system 130 and/or the dispensing apparatus 140, the user may exchange information with the positioning system and/or the dispensing apparatus via the PDA. Programs, commands and other information is inputted by the user to the PDA via any suitable means, such as with an electronic stylus on a touch pad display screen. The PDA communicates such information to the positioning system and/or the dispensing apparatus, which executes one or more actions in response to the communicated information.

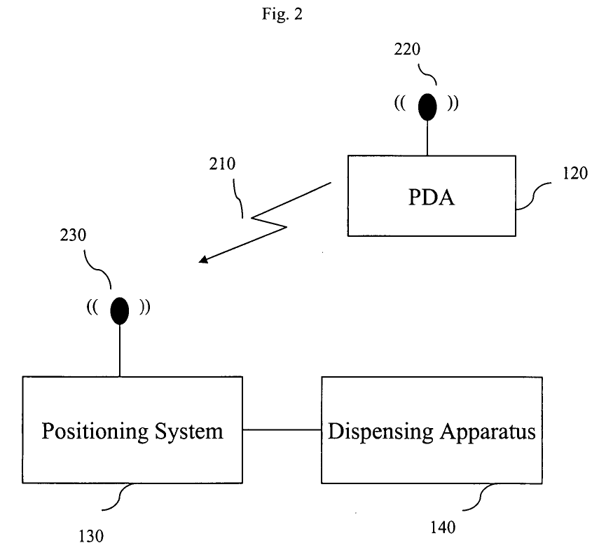

With reference to FIG. 2, in an embodiment of the present invention, a robotic fluid dispensing system includes a PDA 120 which is in wireless communication 210 with a positioning system 130 and/or a dispensing apparatus 140. Wireless communication 210 is facilitated by any suitable wireless mechanism, and may optionally comprise a wireless network. The particular wireless mechanism or wireless network utilized is selected based on the communication requirements of the user of the dispensing system. Any of a number of well known and commercially available systems may be used, including but not limited to BLUETOOTH™ wireless systems, Infrared (IrDA) systems, HomeRF (SWAP) systems, Wi-Fi (WECA) wireless networks, and any IEEE802-11-compatible wireless systems. The selected wireless mechanism is determined by the speed of communication required, the expense of the system and the reliability of the system, among other factors.

In an exemplary embodiment, PDA 120 includes a wireless access device 220 and positioning system 130 includes a wireless access device 230 to comprise a wireless network for wireless communication there between. Wireless access devices 220 and 230 are any suitable devices for facilitating such wireless communication. For example, wireless access devices 220 and 230 are bluetooth-enabled compatible devices.

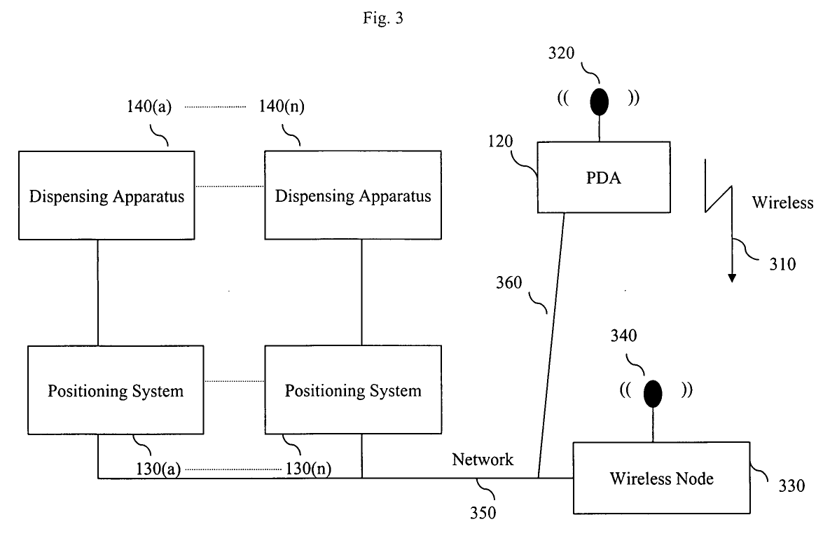

With reference to FIG. 3, in an embodiment of the present invention, a plurality of robotic dispensing systems are controlled and/or monitored by at least one PDA 120. A plurality of dispensing apparatuses 140(a) through 140(n) are coupled with a plurality of positioning systems 130(a) through 130(n) and comprise a plurality of robotic dispensing systems. Each of the plurality of robotic dispensing systems are in electronic communication with each other via a network 350. Network 350 is any suitable network for facilitating electronic communication between the robotic dispensing systems, including but not limited to an Ethernet-based network.

PDA 120 communicates with the plurality of dispensing robots via network 350. PDA 120 connects to network 350 in any suitable manner, including by physical connection 360 or via wireless communication 310. Physical connection 360 is achieved in any suitable manner, including but not limited to by Ethernet connection.

Wireless communication 310 between PDA 120 and network 350 is achieved in any suitable manner. In an embodiment, network 350 includes at least one wireless node 330 for receiving and transmitting wireless communication to and from network 350. Wireless node 340 is any suitable wireless network access point, such as, for example, a router, and includes a transmitter/receiver 340 adapted to wirelessly communicate with other wireless transmitter/receiver(s). In this embodiment, PDA 120 includes at least one transmitter/receiver 320 which is adapted for wireless communication with transmitter/receiver 340. The particular wireless mechanism or wireless network utilized is selected based on the communication requirements of the user of the dispensing system. Any of a number of well known and commercially available systems may be used, including such systems described previously herein.

In this regard, a user may control a plurality of dispensing robots from a single PDA 120. In embodiments including wireless communication between the PDA 120 and the network 350, a user accesses a PDA within transmitting/receiving range of the network 350. The user identifies one or more dispensing machines connected to the network for monitoring and/or control thereof. Commands (and optionally other data) are transmitted from the PDA 120 to one or more dispensing robots via the network 350.

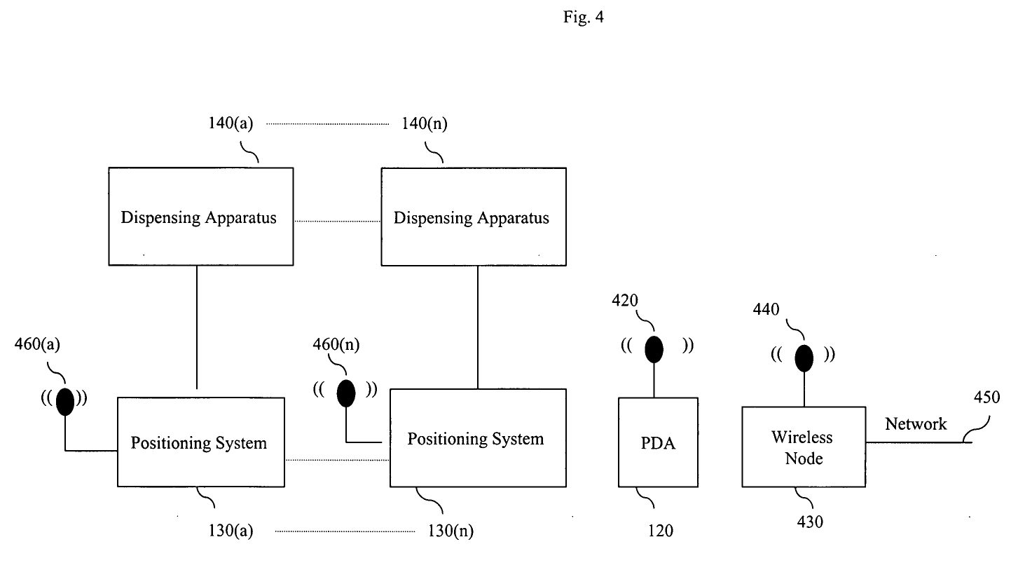

With reference to FIG. 4, in an embodiment of the present invention, a plurality of robotic dispensing systems are controlled and/or monitored by at least one PDA 120 via wireless communication optionally including a wireless network. A plurality of dispensing apparatuses 140(a) through 140(n) are coupled with a plurality of positioning systems 130(a) through 130(n) and comprise a plurality of robotic dispensing systems. Each of the plurality of robotic dispensing systems include a wireless transmitter/receiver 460(a) through 460(n) (e.g., a wireless node for each dispensing system). PDA 120 includes a wireless transmitter/receiver 420 (e.g., a wireless node) adapted for wireless communication with transmitter/receiver(s) 460(a) through 460(n). In this regard a user may control a plurality of dispensing robots wirelessly through one PDA.

With continued reference to FIG. 4, in yet another embodiment, wireless node 430 includes a wireless transmitter/receiver 440 adapted for wireless communication with transmitter/receiver 420 and/or transmitter/receivers 460(a) through 460(n). Wireless node 430 is optionally connected to network 450. In this example, communication between the PDA 120 and the dispensing robots is facilitated by the wireless node 430 and/or by the network 450 connected to the node 430. Transmission of communication from either transmitter/receiver 420 and or transmitter/receivers 460(a) through 460(n) are optionally received by the wireless node 430 and transmitted to an intended recipient (e.g., any one or more of transmitter/receivers 420 and/or 460(a) through 460(n)).

While the invention has been described with reference to a preferred embodiment, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that invention not be limited to the particular embodiment disclosed as the best mode contemplated for carrying out this invention, but that the invention will include all embodiments falling within the scope of the appended claims.

1. A dispensing system comprising:
a dispensing apparatus, a positioning system for controlling the dispensing apparatus and a general purpose PDA for controlling at least the positioning system.

2. The system of claim 1 wherein the dispensing system is a fluid dispensing system and the dispensing apparatus is a fluid dispensing apparatus.

3. The system of claim 1 wherein the PDA communicates with the positioning system via a wired connection.

4. The system of claim 1 wherein the PDA communicates with the positioning system via a wireless communication means.

5. The system of claim 4 wherein the wireless communication means includes at least one bluetooth-compatible device.

6. The system of claim 1, the PDA including dispensing system logic for communication with the positioning system.

7. The system of claim 6, the dispensing system logic for controlling the positioning system including position control logic.

8. The system of claim 6, the dispensing system logic including create program logic and store program logic.

9. The system of claim 1, further including at least one personal computer wherein the PDA has PC import/export logic for communicating with the personal computer.

10. The system of claim 1, the PDA including positioner flash logic for flashing the positioning system.

11. A fluid dispensing system comprising:
at least one fluid dispensing apparatus sized for table top application;
at least one positioning system for directing the dispensing apparatus; and
at least one general purpose PDA for controlling the positioning system, the PDA having dispensing system logic for controlling the positioning system.

12. The system of claim 11 furthering including a bluetooth-compatible wireless communication system.

13. The system of claim 11, the logic for controlling the positioning system including positioner control logic, create programs logic, store programs logic and recall programs logic.

14. A system for dispensing fluid comprising:
a plurality of fluid dispensing apparatuses;
at least one positioning system for each of the plurality of fluid dispensing apparatuses;
at least one general purpose PDA for controlling at least one of the positioning systems; and
a network for facilitating communication between the at least one general purpose PDA and at least one of the positioning systems.

15. The system of claim 14, the network including:
a wired network that connects to the positioning systems; and
a wired connection between the wired network and the PDA.

16. The system of claim 14, the communication network including:
a wired network that connects to the positioning systems; and
a wireless network that connects the PDA to the network.

17. The system of claim 16, the wireless network including:
a wireless node physically connected to the wired network and capable of wireless communication with the PDA, and wherein the PDA is adapted for wireless communication with the access point.

18. The system of claim 17, wherein the wireless node is a router.

19. The system of claim 14, the network including:
a wireless network that connects to the positioning system; and
a wireless connection between the wireless network and the PDA.

20. The system of claim 19, the wireless network including:
a wireless access point, wherein each positioning system is adapted for wireless communication via the wireless access point, and wherein the PDA is adapted for wireless communication with the access point.

21. The system of claim 14, the network including:
a wireless communication device attached to each of the positioning systems, and a wireless communication device attached to at least one PDA, whereby the PDA wirelessly communicates with each positioning system.

22. A method for controlling a liquid dispensing apparatus having a positioning system comprising the steps of:
connecting a general purpose PDA to the positioning system; and
exchanging information between the general purpose PDA and the positioning system.

23. A method for controlling a plurality of liquid dispensing system comprising the steps of:
wirelessly connecting a general purpose PDA to a network, the network communicating with each of the liquid dispensing systems; and
exchanging information between the PDA and the liquid dispensing systems via the wireless connection.

24. A controller for a robotic fluid dispensing system having at least one dispensing apparatus coupled to at least one positioning system, the controller comprising:
a general purpose PDA for controlling the fluid dispensing system, the PDA having dispensing system logic.

25. The controller of claim 24, the dispensing system logic including positioner control logic.

26. The controller of claim 24, the dispensing system logic including create program logic, store program logic and recall program logic.

27. In a fluid dispensing system including a fluid dispensing apparatus and a positioning system, the improvement comprising:
a controller for controlling the fluid dispensing system, the controller including a general purpose PDA having dispensing system logic.

28. The system of claim 6, the dispensing system logic for controlling the positioning system including teach logic.
